(19) United States
(12) Patent Application Publication
(10) Pub. No.: US 2025/0193206 A1
(43) Pub. Date: Jun. 12, 2025

(54) SECURE IDENTIFICATION OF AUTHORIZED LOCATIONS

(71) Applicant: Apple Inc., Cupertino, CA (US)

(72) Inventors: James T. Curran, Cupertino, CA (US); Andrew J. Kerns, Cupertino, CA (US); Daniel S. Haseler, San Jose, CA (US); Michael P. Dal Santo, San Francisco, CA (US)

(73) Assignee: Apple Inc., Cupertino, CA (US)

(21) Appl. No.: 18/972,570

(22) Filed: Dec. 6, 2024

Related U.S. Application Data
(60) Provisional application No. 63/608,284, filed on Dec. 10, 2023.

(51) Int. Cl. H04L 9/40; H04L 67/52

(52) U.S. Cl. CPC H04L 63/107; H04L 63/08; H04L 67/52; H04L 2463/082

(57) ABSTRACT

The techniques described herein can be used for secure identification of authorized locations for use in multi-factor authentication. A set of historical time-stamped coordinates corresponding to a historical time period can be used to determine a set of authorized locations. A request can be received to determine whether a current location of the first user device is an authorized location. A service can determine whether the current location of the first user device corresponds to one of the set of authorized locations.

### CROSS-REFERENCES TO RELATED APPLICATIONS

This application claims the benefit of U.S. Provisional Application No. 63/608,284, filed on Dec. 10, 2023, which is incorporated by reference.

### BACKGROUND

Mobile electronic devices are becoming ubiquitous. Users want to be able to perform high-security operations from their mobile devices. However, users also want to prevent people who have stolen or taken their mobile devices from accessing a user's data and performing high-security operations.

### DESCRIPTION OF THE DRAWINGS

FIG. 1 illustrates a diagram for explaining techniques related to generating authorized locations, according to at least one example.

FIG. 2 illustrates a diagram for explaining techniques related to generating authorized locations, according to at least one example.

FIG. 3 illustrates a diagram for explaining techniques related to determining a user device is located at an authorized locations, according to at least one example.

FIG. 4 illustrates a diagram for explaining techniques related to determining a user device is located at an authorized locations, according to at least one example.

FIG. 5 illustrates an example flow diagram for techniques related determining a user device is located at an authorized locations, according to at least one example.

FIG. 6 illustrates an example architecture or environment configured to implement techniques relating to authorized locations, according to at least one example.

### DETAILED DESCRIPTION

Certain embodiments of the present disclosure relate to techniques (e.g., systems, devices, computer-readable medium, and/or methods) for implementing various features for determining authorized locations for an account and/or set of user devices, and determining if a user device is located at an authorized location. In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Examples of the present disclosure are directed to, among other things, determining authorized locations for an account and/or set of user devices, and determining if a user device is located at an authorized location (e.g., for allowing certain device functions to be performed). User devices (for example, smartphones, laptops, tablets, smartwatches) can be used to perform many high-security operations (e.g., accessing data related to money and financial accounts, accessing highly confidential or private information). User devices may be configured with many forms of security to make sure that only a valid (or authorized) user is able to cause the user device to perform these high-security operations. These forms of security can include passwords and biometric authentication, but hacking and other security-breaking techniques have expanded to thwart these forms of security. Multi-factor authentication can be used to ensure than a valid user is able to perform high-security operations on their own user devices while an attacker (for example, a thief or hacker) is not able to perform high-security operations on the user device.

The techniques described herein include the use of authorized locations as part of a multi-factor authentication scheme. Authorized locations can be associated with an account and the account can be associated with multiple user devices. Oftentimes, users have schedules and patterns that lead to their user devices being in certain locations for larger periods of time than others. Authorized locations can include locations where a user device may be located frequently. In some examples, authorized locations can represent the most frequent and regular locations where a user device of the account may be located. In some examples, authorized locations can be common locations associated with a user of the user device. For example, authorized locations may include the user's home, the user's workplace, the user's place of worship, or a place the user frequents such as a coffee shop or park. Authorized locations can be used as an authentication factor to identify that the rightful user/owner of a user device is currently using the user device.

Authorized locations can be determined based on historical location information for user devices associated with an account. For example, an authorized location can be determined based on location information of one or more user devices during a previous time interval (e.g., a period sufficiently in the past). For example, location information from a prior month (for example, two months ago) for the one or more user devices can be used to determine an authorized location. In another example, location information from a time prior to a last biometric authentication for the one or more devices can be used to determine an authorized location. For example, if a last biometric authentication on a device occurred thirty minutes in the past, the historical location information from prior to thirty minutes in the past can be used to determine an authorized location. Location information that is from a sufficiently past period may be more difficult for an attacker to fake or inject into the user device. In some examples, an adversary may only have possession of a device for a limited amount of time (for example, up to two weeks) prior to the device being marked as lost or the device being recovered. The concept of authorized locations can add additional security to the device during this time window. Data received during the sufficiently past time period (for example, location information) can be seen as valid and trustworthy. In this way, problem of verifying the integrity and validity of the data itself can be reframed to verifying the age of the data. Furthermore, the past period can be a moving time period such that authorized locations are determined on historical location information from a specific amount of time in the past. For example, the past period can be 90-120 days in the past. A sufficiently past time period can be used because an attacker likely only has a user device for a relatively short period of time before the rightful owner realizes the user device may be lost or under attack.

In some examples, an authorized location system can include both a server hosting authorized location services and one or more user devices associated with an account that uses the authorized location services. In some examples, an authorized location system can include a server hosting historical location services for an account and one or more user devices associated with the account. Each device of the one or more user devices are able to request the historical location information from the server and determine whether the user device is located at an authorized location. In some examples, the authorized location services can maintain historical locations for the one or more user devices. In some examples, the authorized location services can determine authorized locations based on the historical locations. As described herein, the authorized locations can be continuously generated and change over time as the historical locations for the one or more user devices change over time. For example, if a user moves to a new city, the historical locations from a sufficiently pass period may be updated to locations within the new city.

Once authorized locations are established for an account, user devices can query the authorized location services (either on device or on a server) to determine if a current location of the user device is an authorized location. A user device may query if a current location of the user device is an authorized location as a factor of multi-factor authentication to enable or disable functionality on the device. For example, an authorized location can be used as a factor in multi-factor authentication to enable the performance of a high-security operation or access high-security information. Additionally and/or alternatively, a user device may query if a current location of the user device is an authorized location to determine if other factors of multi-factor authentication are to be requested in order to authorize a high-security operation or access high-security information. In some examples, a user device associated with an account can determine if the current location of the user device is an authorized location. In some examples, the authorized location services (e.g., hosted on a server) can determine if the current location of the user device is an authorized location.

Determining if the current location of the user device is an authorized location can include one or more checks. The checks can be alternatives or additional steps to confirm that the current location of the user device is an authorized location. In some examples, the user device can use multiple independent types of radio signals or multiple different signals from independent sources to confirm the user device is located at an authorized location. If the multiple different signals confirm that the device is located at the same or nearly the same authorized location, it is more likely that the user device is located at that authorized location. Furthermore, the requirement of multiple independent sources for signals can increase the difficulty for an adversary to fool the authorized location check of the user device. Although attackers can spoof individual signals, it may be more difficult for an attacker to spoof multiple different radio signals of different types. For example, a user device (or an authorized location service) can use an independent cellular signal and an independent global navigation satellite system (GNSS) signal for the user device to confirm the user device is located at an authorized location. A GNSS signal can include a global positioning system (GPS) signal, or another constellation such as Galileo, BeiDou, GLONASS, and the like.

In some examples, the user device can use time-stamped coordinates for the user device and motion sensor history to determine if the time-stamped coordinates are legitimate. For example, time-stamped coordinates (which are determined as a best effort when the user device is connected to location services) for the user device can indicate where the user device reports that it has been. These time-stamped coordinates can be based on signals received by the user device such as cellular signals and GPS signals. However, cellular signals and GPS signals can be faked to indicate that the user device it located an authorized location when the user device is not in fact at an authorized location. However, a user device has a motion sensor (or motion type sensor) that can detect an approximate speed or type of movement that a user device is experiencing. For example, the motion sensor can determine that a user device is moving at a speed consistent with being stationary, or accompanying a user that is walking, running, biking, driving, or flying. These types of movements can be associated with an average speed. In another example, the motion sensor can determine an approximate speed that the user device is moving. The user device (or an authorized location service) can determine a probability whether the approximate speeds or types of movement that the motion sensor detected is consistent with the series of time-stamped coordinates for the user device during a recent past period. For example, the user device can determine a probability whether the user device may have traveled from a time-stamped coordinate at the user's workplace to a time-stamped coordinate at the user's home within the difference between the times of the coordinates. The motion sensor can determine approximate speeds or types of movement that the motion sensor detected between the time-stamped coordinates to determine a probability that the user device could have traveled the distance between the time-stamped coordinates within the time difference.

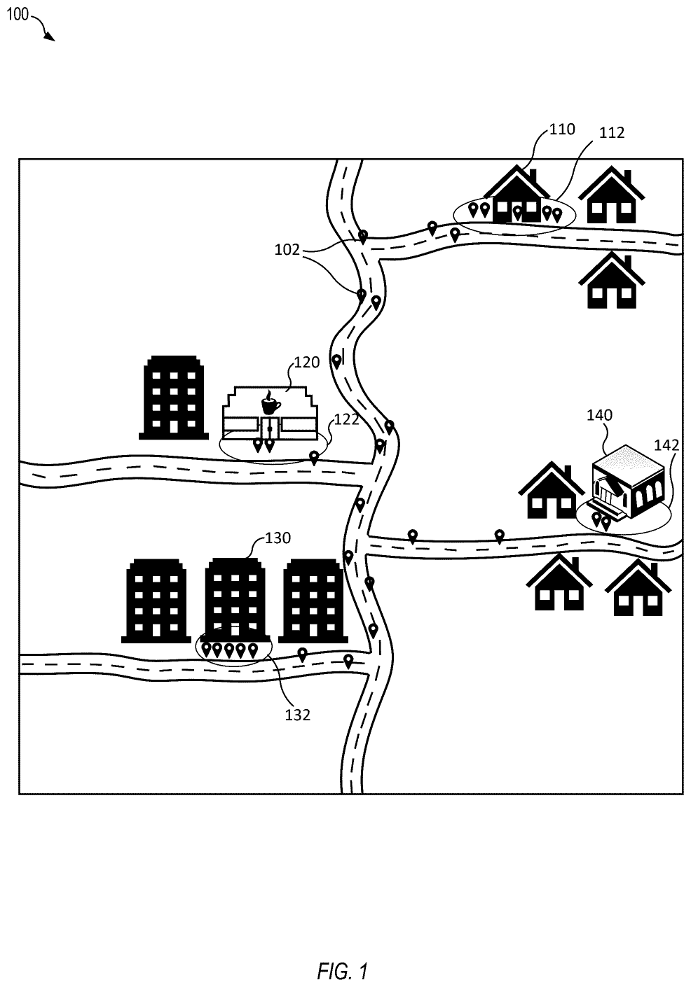

FIG. 1 shows an example map with information used to determine authorized locations. A series of time-stamped coordinates 102 for one or more user devices associated with an account can be stored by an authorized location service. The authorized location service can be hosted on one or more servers and/or hosted on a user device. For example, a user device may host the authorized location service. Time-stamped coordinates 102 from a sufficiently past time period can be used to determine authorized locations by either a server hosting the authorized location service or a user device. For example, a user device can query a server for the series of time-stamped coordinates 102 for one or more user devices associated with the account, and then the user device can determine authorized locations. A sufficiently past time period can be referred to as a historical time period. Similarly, time-stamped coordinates during the sufficiently past time period can be referred to as historical coordinates. In some examples, a sufficiently past time period can be a time period from 90-120 days prior to a current time. In some examples, a sufficiently past time period can be a time period from 7-20 days prior to a current time. Although a sufficiently past time period can be any past time period, generally a sufficiently past time period can be a time period at least one day prior to a current time.

In another example, a sufficiently past time period can be determined based on a time period preceding the last biometric authentication on a device. Example biometric authentication on a device can include fingerprint biometrics, facial recognition-based biometrics, facial feature mapping-based biometrics, and facial depth-mapping-based biometrics. Other biometrics can also be used. Biometric authentication can occur when waking a device from a sleep mode or when using an application on the device that requires a biometric authentication process prior to displaying information. In one example, a sufficiently past time period can be any time prior to the last biometric authentication on the device. For example, if the last biometric authentication on a device was two hours in the past, then any historical coordinates prior to the two hours in the past can be used to determine authorized locations. In another example, a sufficiently past time period can be any time prior to the last biometric authentication on the device up to a particular past point. For example, the particular past point could be 90 days and the last biometric authentication on the device could be one hour in the past. In this example, the sufficiently past time period can be defined from one hour in the past to 90 days in the past and the historical coordinates from that sufficiently past time period can be used to determine authorized locations. In another example, the sufficiently past time period can be a time period up to a time offset prior to the last biometric authentication. For example, a time offset can be one hour and the last biometric authentication can be four hours in the past. In this example, the sufficiently past time period can be defined by any time prior to five hours in the past (the combination of the time offset of one hour and the time since the last biometric authentication). The historical coordinates from this sufficiently past time period can be used to determine authorized locations. These various examples for a sufficiently past time period based on the last biometric authentication on the device can be combined in any suitable manner.

In some examples, different devices may have different sufficiently past time periods defining historical coordinates for each device. For example, biometric authentication on a first device can occur ten minutes in the past and biometric authentication on a second device can occur two days in the past. The historical coordinates of the first device can be from times prior to ten minutes in the past while the historical coordinates of the second device can be from times prior to two days in the past. These historical coordinates from the first and second device can be used to determine authorized locations for the one or more devices.

The authorized location service can determine clusters of historical coordinates to establish locations of interest (LOIs, which can also be referred to as historical LOIs) for the account and/or the one or more devices. In some examples, the LOIs can be geographic areas such as parks, parking lots, or arenas. In some examples, the LOIs can be buildings or addresses such as an office building, a home, a place of worship, a specific address of one of a series of townhomes, or a specific business address in a building hosting multiple business addresses. From the LOIs, the authorized location service can determine authorized locations based on one or more criteria. As described herein, a user device trying to perform a high-security operation being at an authorized location can be used as a factor in multi-factor authentication.

In some examples, the authorized locations can be used across the one or more devices. For example, the authorized locations for each of the one or more devices can be the same set of authorized locations. In some examples, the authorized location service can be used to determine different authorized locations for each of two or more devices. For example, the authorized location service can be used to determine a first set of authorized locations for a first device and a second different set of authorized locations for a second device. The different sets of authorized locations can be based on the historical coordinates of each device. For example, the first set of authorized locations for the first device can be determine based on the historical coordinates of the first device and the second set of authorized locations can be determined based on the historical coordinates of the second device.

In FIG. 1, the authorized location service on a user device can request time-stamped coordinates from a server and determine clusters of time-stamped coordinates 102 at clusters 112, 122, 132, 142 that correspond to a home 110, a coffee shop 120, an office building 130, and a place of worship 140. The authorized location service can determine that one or more user devices associated with an account has multiple time-stamped coordinates 102 at these locations during a time period. Locations associated with clusters of time-stamped coordinates 102 that meet one or more criteria can be LOIs for the particular account. The criteria can include minimum dwell time or an amount of time at the location. In some examples, the authorized location service on a server can perform these functions.

The time-stamping for the time-stamped coordinates 102 can be done in a secure way to maintain integrity of the time being used to time-stamp the coordinates 102. The time-stamping can be done in a non-user or non-adversary manipulatable way. In some examples, the time used to time-stamp the time-stamped coordinates 102 can be derived from satellite navigation signals. In some examples, the time used to time-stamp the time-stamped coordinates 102 can be derived from a trusted server.

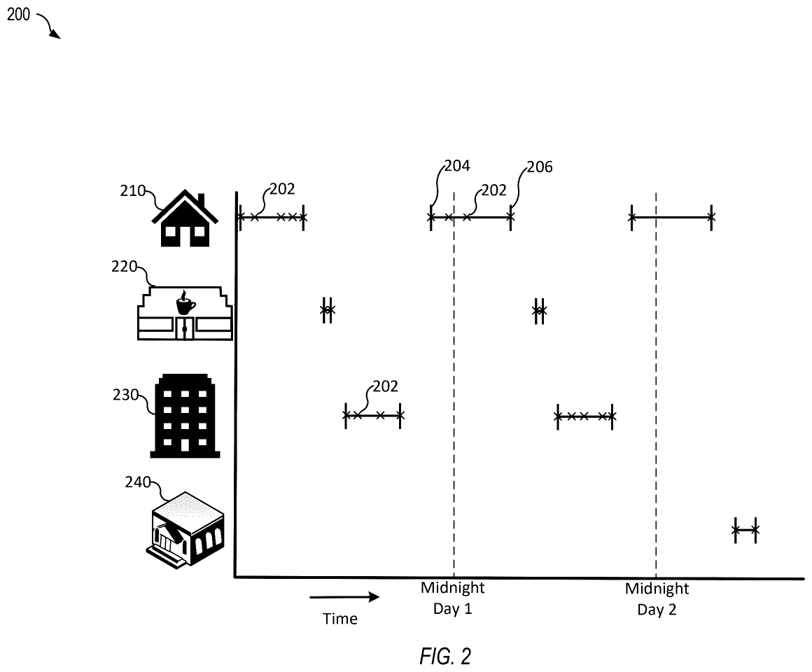

FIG. 2 shows a graphical depiction 200 of example time-stamped coordinates 102 of FIG. 1 at LOIs in relation to the time stamps. The time-stamped coordinates 202 correspond to the time-stamped coordinates 102 of FIG. 1. The x-axis of the graphical depiction 200 is time while the y-axis indicates identified LOIs such as a home 210 (for example, the home 110 of FIG. 1), a coffee shop 220 (for example, the coffee shop 120 of FIG. 1), an office building 230 (for example, the office building 130 of FIG. 1), and a place of worship 240 (for example, a place of worship 140 of FIG. 1). The authorized location service (on a user device or on a server) can use the time-stamped coordinates 202 to determine a dwell time or an amount of time at the LOIs. For example, four consecutive time-stamped coordinates may be at cluster 112 of FIG. 1 associated with the home 110, 210 during a three-hour time period. The first time-stamped coordinate of the four time-stamped coordinates can be used to indicate an arrival 204 and start to the dwell time. The last time-stamped coordinate of the four time-stamped coordinates can be used to indicate a departure 206 and end to the dwell time. Arrivals 204 and departures 206 can also be determined by determining that the time-stamped coordinate immediately preceding and the time-stamped coordinate immediately after the four time-stamped coordinates may be located elsewhere than the LOI (for example, on a road or a different building). The time difference between the arrival 204 at the earliest time-stamped coordinate and the departure 206 at the latest time-stamped coordinate at cluster 112 can be used to determine a dwell time or an amount of time at the home 110, 210.

The authorized location service can also determine visits to LOIs which have an arrival 204 and a departure 206. An arrival 204 at an LOI can be represented by a first time-stamped coordinate of a series of consecutive time-stamped coordinates 202 at the LOI as compared to an immediately preceding time-stamped coordinate not at the LOI. A departure 206 from an LOI can be represented by a last time-stamped coordinate of a series of consecutive time-stamped coordinates 202 at the LOI as compared to an immediately following time-stamped coordinate not at the LOI. For example, the authorized location service can determine that the four time-stamped coordinates during the three-hour time period represent a visit to the home 110. The authorized location service can determine there was an arrival 204 at the home 210 and a departure 206 from the home 210 based on the time-stamped coordinates 202.

In some examples, authorized locations are LOIs that meet one or more criteria. For example, a criteria for an authorized location may be that one or more user devices spend a minimum dwell-time or amount of time at the LOI during the historical time period. In another example, a criteria for an authorized location may be that there was a minimum number of visits to the LOI during the historical time period. In some examples, a criteria for an authorized location may be a minimum number of visits that are each on different days. In some examples, a limited number of LOIs can be designated as an authorized location. In one example, ten LOIs can be designated as authorized locations. When a limited number of LOIs can be designated as an authorized location for an account, the authorized locations can be selected from LOIs that meet minimum criteria. From the LOIs that meet minimum criteria, the authorized locations can be LOIs where the one or more user devices spent the largest amount of dwell-time or largest amount of time at the LOIs during the historical period. For example, an authorized location service may identify twenty LOIs during the historical time period, but the account can only have five authorized locations. The five authorized locations can be the five LOIs with the largest amount of dwell-time for the user devices associated with the account during the historical period.

In some examples, the authorized location service may use a subset of historical coordinates to determine authorized locations. For example, the authorized location service may use historical coordinates that received by the authorized location service within a time period of the timestamp provided by the corresponding user device of the historical coordinates. For example, the authorized location service may use a subset of historical coordinates that are received within two hours of the timestamp provided by the corresponding user device. In this example, a historical coordinate time-stamped by the corresponding user device at 4 a.m. on June 10th can be used to determine authorized locations if the historical coordinate was received by the authorized location service by 6 a.m. on June 10^{th}. By limiting the subset of historical coordinates to determine authorized locations in this way, an attacker may not be able to inject historical coordinates in the historical time period after a maximum time has passed. For example, if an attacker tried to inject a historical coordinate at 4 a.m. on June 10^{th} for a user device but the authorized location service receives the historical coordinate at 10 a.m. on August 30^{th}, the authorized location service can disregard this historical coordinate when determining authorized locations.

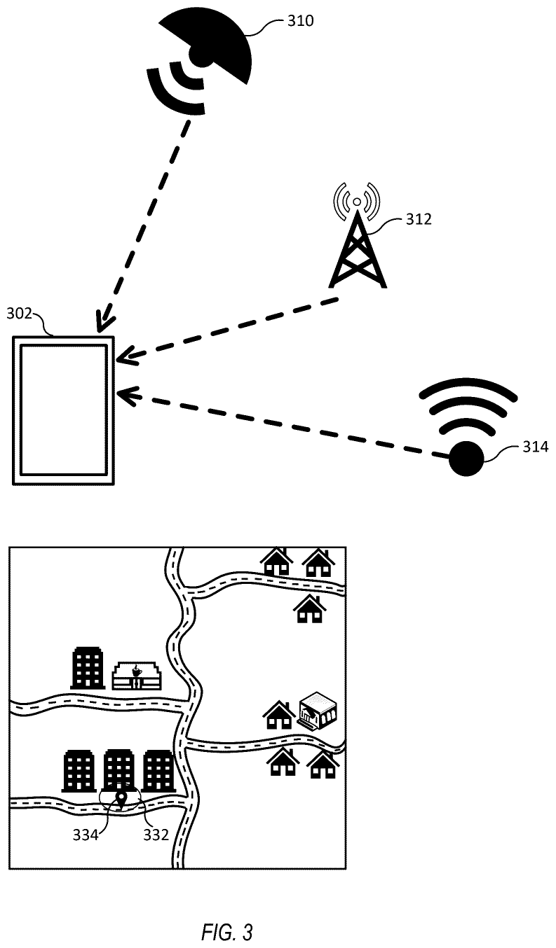

FIG. 3 illustrates an example technique for determining if a user device is located at an authorized location. As described herein, a request to perform high-security operations or access to high-security information on a user device 302 can prompt multi-factor authentication to verify an authorized or valid user is presently using the user device 302. The request can be transmitted to the authorized location services on the user device 302 or to a server hosting authorized location services. In some examples, an application on the user device 302 may request the authorized location services on the user device 302 (or the operating system of the user device 302) to perform multi-factor authentication. In some examples, the application on the user device 302 may use the techniques described herein to determine if a user device 302 is located at an authorized location as a factor of the multi-factor authentication. In some examples, a service from another device (for example, a server device) may request the authorized location service on the user device 302 to perform multi-factor authentication.

One technique that a user device 302 can use to determine if the user device 302 is located at an authorized location confirming that multiple independent radio signals indicate that the user device 302 is located at an authorized location. For example, independent radios signals can include a GPS signal from a GPS system 310, a cellular signal from a cell network 312, and a WiFi signal from a multiaccess point WiFi network 314. These radio signals can be considered independent because a different system or entity is likely to control these signal generators. Each of a GPS signal, a cellular signal, and WiFi signal can include location information regarding the user device 302. The user device 302 can determine that the user device 302 is located at coordinates 334 within an authorized location 332 based at least in part on two or more independent radio signals indicating the user device is located within the authorized location 332. Although an attacker can potentially deploy signal generators to mimic a single radio signal, it may be more difficult for an attacker to deploy two or more signal generators to mimic different independent radio signals which both contain the same location information.

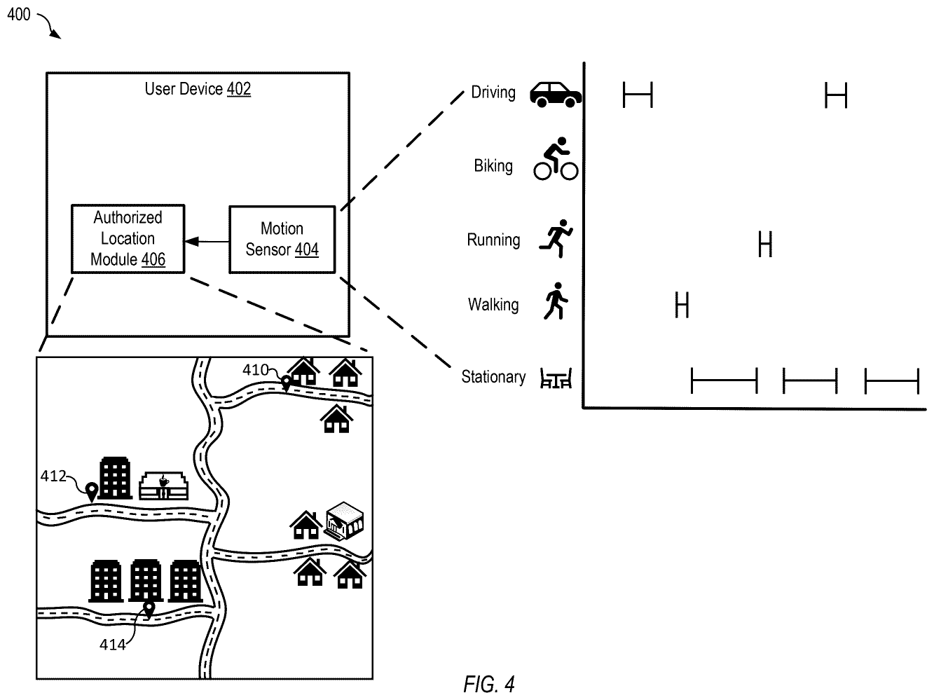

FIG. 4 illustrates an example technique for determining if a user device is located at an authorized location. The user device 402 has a motion sensor 404 (also be referred to as a motion type sensor) that can detect the motion of the user device 402. The motion sensor 404 can use the motion of the user device 402 to generate motion information. In some examples, the motion sensor 404 can be used to determine the orientation of a user device 402. Instead, the motion sensor 404 can detect when the user device 402 is moving or not moving. In some examples, the motion sensor 404 can detect an approximate speed at which the user device 402 is moving. In such an example, the motion information can include an approximate speed at which the user device 402 is moving. The motion sensor 404 can pair the motion information with time information in order to establish the approximate speeds at which the user device 402 is moving and at what times. The motion information and the time information can be stored by the user device 402. In some examples, an accelerometer and gyroscope can be used in conjunction to be and/or perform the functions of the motion sensor 404. In some examples, the motion sensor 404 can receive signals via connectivity to another device (for example, a car). The motion sensor 404 can use the signals from the other device to detect an approximate speed at which the user device 402 is moving.

In some examples, the motion sensor 404 can determine that the user device 402 is being moved via a type of motion. In such an example, the motion information can include a type of motion while a user device is moving. For example, the motion sensor 404 can determine that the user device 402 is stationary or nearly stationary. In some examples, stationary motion can be characterized with movement that is ten centimeters or less per second. In some examples, stationary motion can be characterized with movement that is five centimeters or less per second. In some examples, stationary motion can be characterized with movement that is one centimeters or less per second. In some examples, the motion sensor 404 can determine that the user device 402 is moving in a way that corresponds to the speed of a person walking. In such a situation, the user device 402 may be on the person of a user who is walking. In some examples, the motion sensor 404 can determine that the user device 402 is moving in a way that corresponds to the speed of a person running. In some examples, the motion sensor 404 can determine that the user device 402 is moving in a way that corresponds to the speed of a person biking. In some examples, the motion sensor 404 can determine that the user device 402 is moving in a way that corresponds to the speed of a person driving or being driven (or some kind of motorized transport such as a bus, boat, and the like). In some examples, the motion sensor 404 can determine that the user device 402 is moving in a way that corresponds to the speed of flying in an airplane. The different types of movement can be associated with an approximate speed or an average speed.

The motion information and the time information of the motion sensor 404 can be used to determine if the location of the user device 402 is fake and being spoofed. Some may refer to the use of motion information and time information as an “anti-teleport” check. The motion sensor 404 can send the motion information and the time information to an authorized location module 406 on the user device 402. In some examples, the authorized location module 406 can perform the authorized location services on the user device 402. In some examples, the authorized location module 406 can transmit the information received by the authorized location module 406 to the authorized location services on a server device for processing. The authorized location module 406 can compare the motion information and the time information against time-stamped coordinates that the user device 402 has previously received to determine the probability that the user device was located at the time-stamped coordinates at the corresponding time and have not been injected via an attacker. For example, the user device 402 may have received a time-stamped coordinate 410 near the home of the associated user. At a later time, the user device 402 receives a second time-stamped coordinate 412 at a building. The authorized location module 406 can use the motion information and the time information from the motion sensor 404 to determine that the user device 402 was stationary during the time between the time-stamped coordinate 410 and the second time-stamped coordinate 412. In such a situation, the probability that the user device 402 moved from the time-stamped coordinate 410 and the second time-stamped coordinate 412 is a low possibility and indicative that an attacker may be attempting to fool or bypass the authorized locations factor of the multi-factor authentication on the user device 402. In another example, the authorized location module 406 can use the motion information and the time information from the motion sensor 404 to determine that the user device 402 was stationary for 50% the time between the time-stamped coordinate 410 and the second time-stamped coordinate 412 and moving in a way that corresponds to driving for 50% the time between the time-stamped coordinate 410 and the second time-stamped coordinate 412.

The authorized location module 406 can determine an average distance and/or a maximum distance that the user device 402 may have traveled between the time associated with time-stamped coordinate 410 and the time associated with second time-stamped coordinate 412. These average distances and/or maximum distances can be used to determine the probability that the user device was located at the time-stamped coordinates at the corresponding time and have not been injected via an attacker. The authorized location module 406 can also determine or receive motion sensor accuracy or uncertainty information that can be used to establish how accurate the motion information of the motion sensor 404 may be. The motion sensor accuracy and/or uncertainty information can also be used to determine the probability that the user device was located at the time-stamped coordinates at the corresponding time and have not been injected via an attacker. If a first probability that the user device 402 was located at the time-stamped coordinates at the corresponding time exceeds a first threshold, the authorized location module 406 can determine that location information received via other sensors (for example, from the signals in relation to FIG. 3) can be trusted. If the first probability that the user device 402 was located at the time-stamped coordinates at the corresponding time is below the first threshold, the authorized location module 406 can determine that the user device 402 is not sufficiently confident of where the user device 402 is located. For example, the user device 402 may be under attack from an attacker such that the user device 402 is not sufficiently confident where the user device 402 is located and fail the multi-factor authentication. Alternatively, if a second probability that the user device 402 was not located at the time-stamped coordinates at the corresponding time exceeds a second threshold, the authorized location module 406 can determine that the user device 402 is not sufficiently confident of where the user device 402 is located. For example, the user device 402 may be under attack from an attacker such that the user device 402 is not sufficiently confident where the user device 402 is located and fail the multi-factor authentication. If the second probability that the user device 402 was located at the time-stamped coordinates at the corresponding time is below the threshold, the authorized location module 406 can determine that location information received via other sensors (for example, from the signals in relation to FIG. 3) can be trusted.

In another example, the user device 402 may receive a time-stamped coordinate 410 near their home and at a later time the user device 402 may receive a third time-stamped coordinate 414 at a workplace associated with a user of the user device 402. The authorized location module 406 can receive the motion information and time information from the motion sensor 404 which indicates one or more approximate speeds for the user device 402 between a time associated with the time-stamped coordinate 410 and another time associated with the third time-stamped coordinate 414. For example, the authorized location module 406 can determine from the motion information and time information from the motion sensor 404 that the user device 402 moved at three different speeds between the time associated with the time-stamped coordinate 410 and the other time associated with the third time-stamped coordinate 414. The authorized location module 406 can determine an average distance and/or a maximum distance that the user device 402 may have traveled between the time associated with time-stamped coordinate 410 and the time associated with second time-stamped coordinate 412 based on the three different speeds and corresponding length of time traveling at the three different speeds. These average distances and/or maximum distances can be used to determine the probability that the user device was located at the time-stamped coordinates at the corresponding time and have not been injected via an attacker. The authorized location module 406 can also determine or receive motion sensor accuracy or uncertainty information that can be used to establish how accurate the motion information of the motion sensor 404 may be. The motion sensor accuracy and/or uncertainty information can also be used to determine the probability that the user device was located at the time-stamped coordinates at the corresponding time and have not been injected via an attacker.

Although we have described each technique for confirming whether a user device is located at an authorized location separately, multiple techniques can be used sequentially or in parallel. For example, a user device may first confirm that multiple independent radio signals indicate that the user device is located at an authorized location as described in relation to FIG. 3 and then confirm the time-stamped coordinates via motion sensor derived information as described in relation to FIG. 4. Alternatively, may first confirm the time-stamped coordinates via motion sensor derived information as described in relation to FIG. 4 and then confirm that multiple independent radio signals indicate that the user device is located at an authorized location as described in relation to FIG. 3.

Additionally, confirming that a user device 402 is located at an authorized location can have a time component. For example, the user device 402 may determine that historical visits to an authorized location occur during certain times-of-day or times-of-week. If a current location of the user device 402 at an authorized location is sufficiently deviant from the historical visits, the user device 402 may determine that the user device 402 is not sufficiently confident where the user device 402 is located. For example, if an authorized location is a workplace and the time is 4 a.m. when the user device has historically been at home, the user device 402 is not sufficiently confident where the user device 402 is located.

Each technique described herein for confirming whether a user device is located at an authorized location can be performed on the user device (for example, by the authorized location module 406 of FIG. 4) or can be performed by an authorized location service on one or more servers. The authorized location service and the user device may need to request and transmit information from each other in order to perform these techniques. For example, with relation to FIG. 3, the user device 302 may transmit the radio signals to the authorized location service to determine if the user device 302 is located at the authorized location 332. In another example, with relation to FIG. 4, the user device 402 may transmit the motion information and time information generated by the motion sensor 404 to the authorized location service. Additionally, the user device 402 may transmit the time-stamped coordinates 410, 412, 414 to the authorized location service. The authorized location service can determine a probability that the user device was located at the time-stamped coordinates at the corresponding time and have not been injected via an attacker.

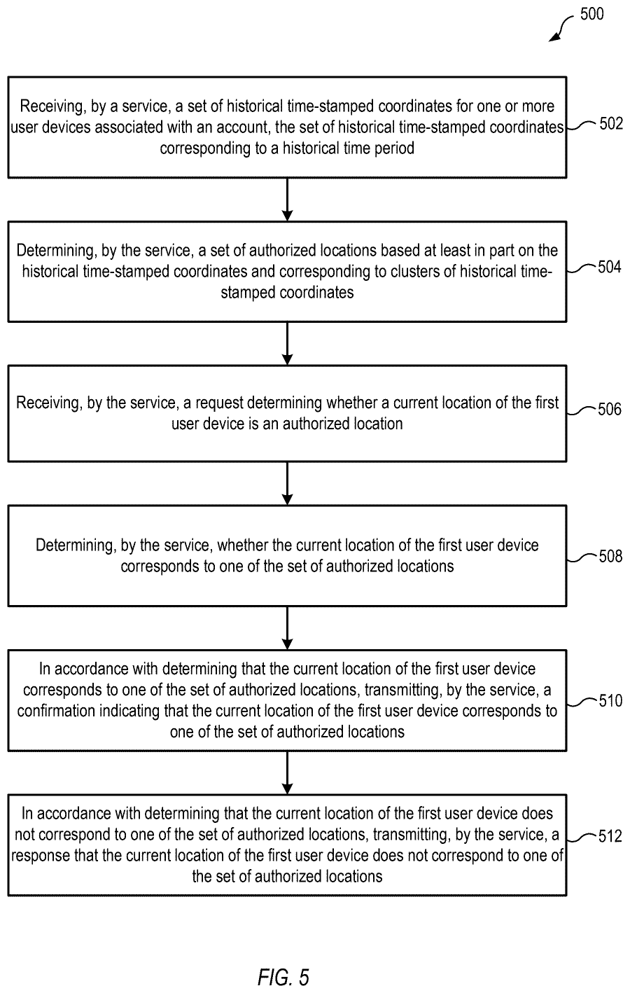

FIG. 5 illustrates an example process 500 for determining and using authorized locations as described herein. Example process 500 can be implemented by authorized location services running on a server or a user device (for example, user device 302 of FIG. 3) running.

At block 502, a service can receive a set of historical time-stamped coordinates for one or more user devices associated with an account. The set of historical time-stamped coordinates can correspond to a historical time period. The historical time period can correspond to a time period that is at least a first particular length of time prior to a present time and no more than a second particular length of time prior to the present time, and wherein the first particular length of time is shorter than the second particular length of time. The service can be running on the first user device. The service can be running on one or more server devices.

At block 504, the service can determine a set of authorized locations based at least in part on the historical time-stamped coordinates and corresponding to clusters of historical time-stamped coordinates. Determining the set of authorized locations can include determining, by the service, a set of historical locations based at least in part on the historical time-stamped coordinates, the set of historical locations corresponding to clusters of time-stamped coordinates. Determining the set of authorized locations can include determining, by the service, an amount of time at each of the set of historical locations based at least in part on the time-stamped historical coordinates. Determining the set of authorized locations can include determining, by the service, the set of authorized locations based at least in part on the amount of time at each of the set of historical locations. Determining the set of authorized locations can be further based at least in part on a minimum amount of time at a historical location. Determining the set of authorized locations can include determining, by the service, a set of historical locations based at least in part on the historical time-stamped coordinates, the set of historical locations corresponding to clusters of time-stamped coordinates. Determining the set of authorized locations can include determining, by the service, individual visits to the set of historical locations based at least in part on the time-stamped historical coordinates, each visit of the individual visits including an arrival and a departure. Determining the set of authorized locations can include determining, by the service, the set authorized locations based at least in part on a minimum number of visits. Determining the set of authorized locations can include identifying, by the service, arrivals for each of the set of historical locations based at least in part on a minimum amount of time at each historical location. Determining the set of authorized locations can include identifying, by the service, departures for each of the set of historical locations based at least in part on identifying an arrival for each historical location and receiving subsequent historical time-stamped coordinates at a different location. Determining the set of authorized locations can include determining a building or geographic area to designate as a location-of-interest based at least in part on the time-stamped historical coordinates.

At block 506, the service can receive a request determining whether a current location of the first user device is an authorized location. The request can further include speed-tracking information from a speed-tracking sensor of the first user device for a second historical time period, the speed-tracking information corresponding to a second set of time-stamped coordinates for the first user device during the second historical time period. The speed-tracking sensor of the first user device can be configured to determine one or more approximate speeds at which the first user device was moving during the second historical time period. The speed-tracking sensor of the first user device can be configured to determine a set of types of movements at which the first user device was moving during the second historical time period. The types of movements can include one or more of: stationary, walking, running, biking, driving, or flying. The request can further include first location information from a first radio signal received by the first user device and second location information from a second radio signal received by the second user device. The first radio signal and the second radio signal can be different types of radio signals. The types of radio signals can include: cellular signals, global navigation satellite system (GNSS) signals, and multi-access point WiFi signals. The request can be received from a second service on the first user device. The request can be received from a second service running on one or more server devices. The request can be received from the first user device and includes a current location of the first user device.

At block 508, the service can determine whether the current location of the first user device corresponds to one of the set of authorized locations. At block 510, the service, in accordance with determining that the current location of the first user device corresponds to one of the set of authorized locations, can transmit a confirmation indicating that the current location of the first user device corresponds to one of the set of authorized locations. At block 512, the service, in accordance with determining that the current location of the first user device does not correspond to one of the set of authorized locations, can transmit a response that the current location of the first user device does not correspond to one of the set of authorized locations. The confirmation and response can be transmitted to the second service. The confirmation and response can be transmitted to the second service. The confirmation and the response can be transmitted to the first user device.

The process 500 can further include the historical time period corresponds to a time period that is at least a first particular length of time prior to a present time and no more than a second particular length of time prior to the present time, and wherein the first particular length of time is shorter than the second particular length of time. The time-stamps of the set of historical time-stamped coordinates can be time-stamped by the one or more user devices. Determining the set of authorized locations can be based at least in part on historical time-stamped coordinates that have a time-stamp within a first time difference from a corresponding receipt time.

The process 500 can further include determining, by the service, a probability of whether the first user device could have traveled through the second set of time-stamped coordinates during the second historical time period based at least in part on the speed-tracking information. In accordance with a determination that the probability is at or above a threshold, the service can determine that the current location of the first user device is a valid location of the first user device. In accordance with a determination that the probability is below a threshold, the service can determine that the current location of the first user device is an invalid location of the first user device. Determining the probability of whether the first user device could have traveled through the second set of time-stamped coordinates during the second historical time period can further include determining, by the service, for each pair of consecutive time-stamped coordinates in the second set of time-stamped coordinates, an average distance that the first user device potentially traveled and a distance uncertainty, the average distance and the distance uncertainty determined based at least in part on the speed-tracking information between times associated with the consecutive time-stamped coordinates. Determining the probability of whether the first user device could have traveled through the second set of time-stamped coordinates during the second historical time period can further include determining, by the service, for each pair of consecutive time-stamped coordinates, a plausibility percentage based at least in part on an actual distance between the consecutive time-stamped coordinates, the average distance, and the distance uncertainty. Determining the probability of whether the first user device could have traveled through the second set of time-stamped coordinates can be based at least in part on the plausibility percentage for each pair of consecutive time-stamped coordinates.

The process 500 can further include determining, by the service, a probability of whether the first user device could have traveled through the second set of time-stamped coordinates during the second historical time period based at least in part on the speed-tracking information. Determining the probability of whether the first user device could have traveled through the second set of time-stamped coordinates during the second historical time period can further include determining, by the service, an average speed for each type of movement at which the first user device was moving during the second historical time period. Determining the probability of whether the first user device could have traveled through the second set of time-stamped coordinates during the second historical time period can further include determining, by the service, for each pair of consecutive time-stamped coordinates in the second set of time-stamped coordinates, an average distance and a distance uncertainty determined based at least in part on the average speed for each type of movement. Determining the probability of whether the first user device could have traveled through the second set of time-stamped coordinates during the second historical time period can further include determining, by the service, for each pair of consecutive time-stamped coordinates, a plausibility percentage based at least in part on an actual distance between the consecutive time-stamped coordinates, the average distance, and the distance uncertainty. Determining the probability of whether the first user device could have traveled through the second set of time-stamped coordinates can be based at least in part on the plausibility percentage for each pair of consecutive time-stamped coordinates.

Determining whether the current location of the first user device corresponds to one of the set of authorized locations can further include determining, by the service, whether the first location information and the second location information correspond to one of the set of authorized locations. Determining whether the current location of the first user device corresponds to one of the set of authorized locations can further include in accordance with determining the first location information and the second location information correspond to one of the set of authorized locations, determining the current location of the first user device corresponds to one of the set of authorized locations. The process 500 can further include in accordance with determining the first location information and the second location information do not correspond to one of the set of authorized locations, determining the current location of the first user device does not correspond to one of the set of authorized locations.

The first user device can be configured to determine whether to conduct a secure operation based at least in part on the first user device being at one of the authorized locations. The first user device can be configured to perform multi-factor authentication, wherein the first user device being at one of the authorized locations is a factor of the multi-factor authentication. The first user device can be configured to perform an authentication operation and a lesser authentication operation, wherein the lesser authentication operation requires fewer factors, and wherein the first user device is configured determine whether to conduct the lesser authentication operation based at least in part on the first user device being at one of the authorized locations.

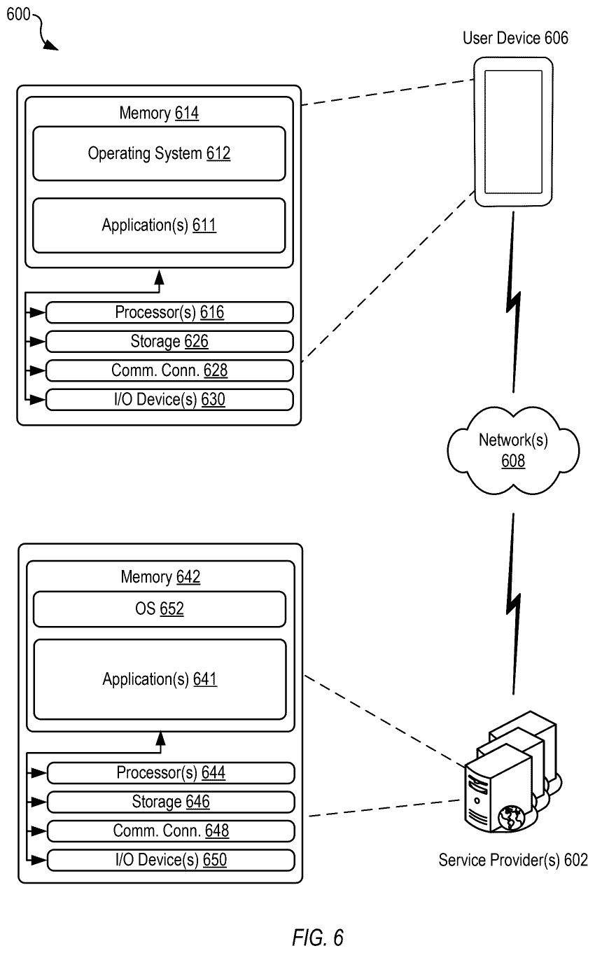

FIG. 6 illustrates an example architecture or environment 600 configured to implement techniques described herein, according to at least one example. The architecture 600 includes a user device 606 (e.g., the user device 302) and a service provider computer 602 (e.g., hosting the authorized location service). In some examples, the example architecture 600 may further be configured to enable the user device 606 and the service provider computer 602 to share information. In some examples, the devices may be connected via one or more networks 608 (e.g., via Bluetooth, WiFi, the Internet). In some examples, the service provider computer 602 may be configured to implement at least some of the techniques described herein with reference to the user device 606 and vice versa.

In some examples, the networks 608 may include any one or a combination of many different types of networks, such as cable networks, the Internet, wireless networks, cellular networks, satellite networks, other private and/or public networks, or any combination thereof. While the illustrated example represents the user device 606 accessing the service provider computer 602 via the networks 608, the described techniques may equally apply in instances where the user device 606 interacts with the service provider computer 602 over a landline phone, via a kiosk, or in any other manner. It is also noted that the described techniques may apply in other client/server arrangements (e.g., set-top boxes), as well as in non-client/server arrangements (e.g., locally stored applications, peer-to-peer configurations).

As noted above, the user device 606 may be any type of computing device such as, but not limited to, a mobile phone, a smartphone, a personal digital assistant (PDA), a laptop computer, a desktop computer, a thin-client device, a tablet computer, a wearable device such as a smart watch, or the like. In some examples, the user device 606 may be in communication with the service provider computer 602 via the network 608, or via other network connections.

In one illustrative configuration, the user device 606 may include at least one memory 614 and one or more processing units (or processor(s)) 616. The processor(s) 616 may be implemented as appropriate in hardware, computer-executable instructions, firmware, or combinations thereof. Computer-executable instructions or firmware implementations of the processor(s) 616 may include computer-executable or machine-executable instructions written in any suitable programming language to perform the various functions described. The user device 606 may also include geo-location devices (e.g., a global positioning system (GPS) device or the like) for providing and/or recording geographic location information associated with the user device 606. In some examples, the processors 616 may include a GPU and a CPU.

The memory 614 may store program instructions that are loadable and executable on the processor(s) 616, as well as data generated during the execution of these programs. Depending on the configuration and type of the user device 606, the memory 614 may be volatile (such as random access memory (RAM)) and/or non-volatile (such as read-only memory (ROM), flash memory). The user device 606 may also include additional removable storage and/or non-removable storage 626 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 614 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 614 and the additional storage 626, both removable and non-removable, are all examples of non-transitory computer-readable storage media. For example, non-transitory computer-readable storage media may include volatile or non-volatile, removable or non-removable media implemented in any method or technology for storage of information such as computer-readable instructions, data structures, program modules, or other data. The memory 614 and the additional storage 626 are both examples of non-transitory computer-storage media. Additional types of computer-storage media that may be present in the user device 606 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 606. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 606 may also contain communications connection(s) 628 that allow the user device 606 to communicate with a data store, another computing device or server, user terminals, and/or other devices via the network 608. The user device 606 may also include I/O device(s) 630, such as a keyboard, a mouse, a pen, a voice input device, a touch screen input device, a display, speakers, and a printer.

Turning to the contents of the memory 614 in more detail, the memory 614 may include an operating system 612 and/or one or more application programs or services for implementing the features disclosed herein such as applications 611 (e.g., the authorized location module 406, etc.). Applications 611 (e.g., the authorized location module 506) can perform some or all the techniques (or corresponding techniques) as described with reference to the processes 500. Similarly, at least some techniques described with reference to the service provider computer 602 may be performed by the user device 606.

The service provider computer 602 may also be any type of computing device such as, but not limited to, a collection of virtual or “cloud” computing resources, a remote server, a mobile phone, a smartphone, a PDA, a laptop computer, a desktop computer, a thin-client device, a tablet computer, a wearable device, a server computer, or a virtual machine instance. In some examples, the service provider computer 602 may be in communication with the user device 606 via the network 608, or via other network connections.

In one illustrative configuration, the service provider computer 602 may include at least one memory 642 and one or more processing units (or processor(s)) 644. The processor(s) 644 may be implemented as appropriate in hardware, computer-executable instructions, firmware, or combinations thereof. Computer-executable instructions or firmware implementations of the processor(s) 644 may include computer-executable or machine-executable instructions written in any suitable programming language to perform the various functions described.

The memory 642 may store program instructions that are loadable and executable on the processor(s) 644, as well as data generated during the execution of these programs. Depending on the configuration and type of service provider computer 602, the memory 642 may be volatile (such as RAM) and/or non-volatile (such as ROM and flash memory). The service provider computer 602 may also include additional removable storage and/or non-removable storage 646 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 642 may include multiple different types of memory, such as SRAM, DRAM, or ROM. While the volatile memory described herein may be referred to as RAM, any volatile memory that would not maintain data stored therein, once unplugged from a host and/or power, would be appropriate. The memory 642 and the additional storage 646, both removable and non-removable, are both additional examples of non-transitory computer-readable storage media.

The service provider computer 602 may also contain communications connection(s) 648 that allow the service provider computer 602 to communicate with a data store, another computing device or server, user terminals, and/or other devices via the network 608. The service provider computer 602 may also include I/O device(s) 650, such as a keyboard, a mouse, a pen, a voice input device, a touch input device, a display, speakers, and a printer.

Turning to the contents of the memory 642 in more detail, the memory 642 may include an operating system 652 and/or one or more application programs 641 or services for implementing the features disclosed herein. Applications 641 (e.g., the authorized location service) can perform some or all of the techniques (or corresponding techniques) as described with reference to the processes 500.

The various examples can be further implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, keypad), and at least one output device (e.g., a display device, printer, speaker). Such a system may also include one or more storage devices, such as disk drives, optical storage devices, and solid-state storage devices such as RAM or ROM, as well as removable media devices, memory cards, flash cards, etc.

Such devices can also include a computer-readable storage media reader, a communications device (e.g., a modem, a network card (wireless or wired), an infrared communication device), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets), or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.
Clause 1: A computer-implemented method, comprising: receiving, by a first user device, an authorized location request to determine whether the first user device is located at a specific location of a plurality of authorized locations; receiving, by the first user device, a set of time-stamped coordinates for the first user device corresponding to a previous time period; determining, by the first user device, a probability of whether the first user device could have traveled through the set of time-stamped coordinates during the previous time period; and in accordance with a determination that the probability is at or above a threshold, determining, by the first user device, to perform a secure operation.
Clause 2: The computer-implemented method of clause 1, wherein determining the probability of whether the first user device could have traveled through the set of time-stamped coordinates is based at least in part on speed-tracking information from a speed-tracking sensor of the first user device.
Clause 3: The computer-implemented method of clause 2, wherein the speed-tracking sensor of the first user device is configured to determine one or more approximate speeds at which the first user device was moving during the previous time period.
Clause 4: The computer-implemented method of clause 3, wherein determining the probability of whether the first user device could have traveled through the set of time-stamped coordinates includes: determining, by the first user device, for each set of consecutive time-stamped coordinates, an average distance that the first user device potentially traveled and a distance uncertainty, the average distance and the distance uncertainty determined based at least in part on the speed-tracking information between times associated with the consecutive time-stamped coordinates; determining, by the first user device, for each set of consecutive time-stamped coordinates, a plausibility percentage based at least in part on an actual distance between the consecutive time-stamped coordinates, the average distance, and the distance uncertainty; and wherein determining the probability of whether the first user device could have traveled through the set of time-stamped coordinates is based at least in part on the plausibility percentage for each set of consecutive time-stamped coordinates.
Clause 5: The computer-implemented method of any of clauses 1-4, wherein the speed-tracking sensor of the first user device configured to determine a set of types of movements at which the first user device was moving during the previous time period.
Clause 6: The computer-implemented method of clause 5, wherein types of movements includes one or more of: stationary, walking, running, biking, driving, or flying.
Clause 7: The computer-implemented method of any of clauses 5-6, determining the probability of whether the first user device could have traveled through the set of time-stamped coordinates includes: determining, by the first user device, an average speed for each type of movement at which the first user device was moving during the previous time period; determining, by the first user device, for each set of consecutive time-stamped coordinates, an average distance and a distance uncertainty, the average distance and the distance uncertainty determined based at least in part on the average speed for each type of movement; determining, by the first user device, for each set of consecutive time-stamped coordinates, a plausibility percentage based at least in part on an actual distance between the consecutive time-stamped coordinates, the average distance, and the distance uncertainty; and wherein determining the probability of whether the first user device could have traveled through the set of time-stamped coordinates is based at least in part on the plausibility percentage for each set of consecutive time-stamped coordinates.
Clause 8: The computer-implemented method of any of clauses 1-7, wherein prior to determining the probability of whether the first user device could have traveled through the set of time-stamped coordinates during the previous time period, the method further comprising: receiving, by the first user device from a first radio signal, first location information; receiving, by the first user device from a second radio signal, second location information; determining, by the first user device, whether the first location information and the second location information correspond to one of the plurality of authorized locations; in accordance with determining the first location information and the second location information correspond to one of the plurality of authorized locations, proceeding with determining the probability of whether the first user device could have traveled through the set of time-stamped coordinates during the previous time period; and in accordance with determining that either the first location information or the second location information do not correspond to one of the plurality of authorized locations, determining, by the first user device, to perform a secure operation.
Clause 9: The computer-implemented method of clause 8, wherein the first radio signal and the second radio signal are different types of radio signals.
Clause 10: The computer-implemented method of any of clauses 8-9, wherein the types of radio signals include: cellular signals, global positioning system (GPS) signals, and multi-access point WiFi signals.
Clause 11: The computer-implemented method of any of clauses 1-10, wherein the set of time-stamped coordinates is received from a service running on one or more server devices.
Clause 12: The computer-implemented method of any of clauses 1-11, further comprising: in accordance with a determination that the probability is below a threshold, transmitting, by the first user device, an authorized location response indicating that the first user device is not at one of the plurality of authorized locations.
Clause 13: The computer-implemented method of any of clauses 1-12, wherein the secure operation is associated with the use of one of: privacy information, security information, or financial information.
Clause 14: A system, comprising: a storage medium configured to store computer-executable instructions; and one or more processors coupled to the storage medium and configured to execute the computer-executable instructions to at least perform the method of any of clauses 1-13.
Clause 15: A computer-readable storage medium having stored thereon program instructions that, when executed by one or more processors of one or more devices, cause the one or more devices to perform the method of any of clauses 1-13.
Clause 16: A computer-implemented method, comprising: receiving, by a first server device from a first user device, an authorized location request to determine whether the first user device is located at a specific location of a plurality of authorized locations; receiving, by the first server device, speed-tracking information from a speed-tracking sensor of the first user device for a previous time period, the speed-tracking information corresponding to a set of time-stamped coordinates for the first user device during the previous time period; determining, by the first server device, a probability of whether the first user device could have traveled through the set of time-stamped coordinates during the previous time period based at least in part on the speed-tracking information; and in accordance with a determination that the probability is at or above a threshold, transmitting, by the first server device to the first user device, an authorized location response indicating that the first user device is located at one of the plurality of authorized locations.
Clause 17: The computer-implemented method of clause 16 wherein the speed-tracking sensor of the first user device is configured to determine one or more approximate speeds at which the first user device was moving during the previous time period.
Clause 18: The computer-implemented method of Clause 17, wherein determining the probability of whether the first user device could have traveled through the set of time-stamped coordinates includes: determining, by the first server device, for each set of consecutive time-stamped coordinates, an average distance that the first user device potentially traveled and a distance uncertainty, the average distance and the distance uncertainty determined based at least in part on the speed-tracking information between times associated with the consecutive time-stamped coordinates; determining, by the first server device, for each set of consecutive time-stamped coordinates, a plausibility percentage based at least in part on an actual distance between the consecutive time-stamped coordinates, the average distance, and the distance uncertainty; and wherein determining the probability of whether the first user device could have traveled through the set of time-stamped coordinates is based at least in part on the plausibility percentage for each set of consecutive time-stamped coordinates.
Clause 19: The computer-implemented method of any of clauses 16-18, wherein the speed-tracking sensor of the first user device configured to determine a set of types of movements at which the first user device was moving during the previous time period.
Clause 20: The computer-implemented method of clause 19, wherein types of movements includes one or more of: stationary, walking, running, biking, driving, or flying.
Clause 21: The computer-implemented method of any of clauses 19-20, determining the probability of whether the first user device could have traveled through the set of time-stamped coordinates includes: determining, by the first server device, an average speed for each type of movement at which the first user device was moving during the previous time period; determining, by the first server device, for each set of consecutive time-stamped coordinates, an average distance and a distance uncertainty, the average distance and the distance uncertainty determined based at least in part on the average speed for each type of movement; determining, by the first server device, for each set of consecutive time-stamped coordinates, a plausibility percentage based at least in part on an actual distance between the consecutive time-stamped coordinates, the average distance, and the distance uncertainty; and wherein determining the probability of whether the first user device could have traveled through the set of time-stamped coordinates is based at least in part on the plausibility percentage for each set of consecutive time-stamped coordinates.
Clause 22: The computer-implemented method of any of clauses 16-21, wherein prior to determining the probability of whether the first user device could have traveled through the set of time-stamped coordinates during the previous time period, the method further comprising: receiving, by the first server device from the first user device, first location information corresponding to a first signal received by the first user device; receiving, by the first server device from the first user device, second location information corresponding to a second signal received by the first user device; determining, by the first server device, whether the first location information and the second location information correspond to one of the plurality of authorized locations; in accordance with determining the first location information and the second location information correspond to one of the plurality of authorized locations, proceeding with determining the probability of whether the first user device could have traveled through the set of time-stamped coordinates; and in accordance with determining that either the first location information or the second location information do not correspond to one of the plurality of authorized locations, transmitting, by the first server device to the first user device, the authorized location response indicating that the first user device is not at one of the plurality of authorized locations.
Clause 23: The computer-implemented method of clause 22, wherein the first radio signal and the second radio signal are different types of radio signals.
Clause 24: The computer-implemented method of any of clauses 22-23, wherein the types of radio signals include: cellular signals, global positioning system (GPS) signals, and multi-access point WiFi signals.
Clause 25: The computer-implemented method of any of clauses 16-24, further comprising: in accordance with a determination that the probability is below a threshold, transmitting, by the first server device to the first user device, an authorized location response indicating that the first user device is not at one of the plurality of authorized locations.
Clause 26: The computer-implemented method of any of clauses 16-25, wherein the first user device is configured to perform a secure operation based at least in part on the authorized location response indicating that the first user device is located at one of the plurality of authorized locations.
Clause 27: The computer-implemented method of any of clauses 16-26, wherein the secure operation is associated with the use of one of: privacy information, security information, or financial information.
Clause 28: A system, comprising: a storage medium configured to store computer-executable instructions; and one or more processors coupled to the storage medium and configured to execute the computer-executable instructions to at least perform the method of any of clauses 16-27.
Clause 29: A computer-readable storage medium having stored thereon program instructions that, when executed by one or more processors of one or more devices, cause the one or more devices to perform the method of any of clauses 16-27.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

As described above, one aspect of the present technology is the gathering and use of data available from various sources to provide a comprehensive and complete window to a user's personal health record. The present disclosure contemplates that in some instances, this gathered data may include personally identifiable information (PII) data that uniquely identifies or can be used to contact or locate a specific person. Such personal information data can include demographic data, location-based data, telephone numbers, email addresses, Twitter IDs, home addresses, data or records relating to a user's health or level of fitness (e.g., vital sign measurements, medication information, exercise information), date of birth, health record data, or any other identifying or personal or health information.

The present disclosure recognizes that the use of such personal information data, in the present technology, can be used to the benefit of users. For example, the personal information data can be used to provide enhancements to a user's experience with multi-factor authentication services. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the U.S., collection of or access to certain health data may be governed by federal and/or state laws, such as the Health Insurance Portability and Accountability Act (HIPAA); whereas health data in other countries may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services or other services relating to health record management, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A computer-implemented method, comprising:
receiving, by a service, a set of historical time-stamped coordinates for one or more user devices associated with an account, the set of historical time-stamped coordinates corresponding to a historical time period;
determining, by the service, a set of authorized locations based at least in part on the historical time-stamped coordinates and corresponding to clusters of historical time-stamped coordinates;
receiving, by the service, a request determining whether a current location of a first user device is an authorized location;
determining, by the service, whether the current location of the first user device corresponds to one of the set of authorized locations;
in accordance with determining that the current location of the first user device corresponds to one of the set of authorized locations, transmitting, by the service, a confirmation indicating that the current location of the first user device corresponds to one of the set of authorized locations; and
in accordance with determining that the current location of the first user device does not correspond to one of the set of authorized locations, transmitting, by the service, a response that the current location of the first user device does not correspond to one of the set of authorized locations.

2. The computer-implemented method of claim 1, wherein determining the set of authorized locations includes:
determining, by the service, a set of historical locations based at least in part on the historical time-stamped coordinates, the set of historical locations corresponding to clusters of time-stamped coordinates;
determining, by the service, an amount of time at each of the set of historical locations based at least in part on the time-stamped historical coordinates; and
determining, by the service, the set of authorized locations based at least in part on the amount of time at each of the set of historical locations.

3. The computer-implemented method of claim 1, wherein determining the set of authorized locations is further based at least in part on a minimum amount of time at a historical location.

4. The computer-implemented method of claim 1, wherein determining the set of authorized locations includes:
determining, by the service, a set of historical locations based at least in part on the historical time-stamped coordinates, the set of historical locations corresponding to clusters of time-stamped coordinates;
determining, by the service, individual visits to the set of historical locations based at least in part on the time-stamped historical coordinates, each visit of the individual visits including an arrival and a departure; and
determining, by the service, the set authorized locations based at least in part on a minimum number of visits.

5. The computer-implemented method of claim 4, wherein determining the set of authorized locations further includes:
identifying, by the service, arrivals for each of the set of historical locations based at least in part on a minimum amount of time at each historical location; and
identifying, by the service, departures for each of the set of historical locations based at least in part on identifying an arrival for each historical location and receiving subsequent historical time-stamped coordinates at a different location.

6. The computer-implemented method of claim 2, wherein determining the set of historical locations includes determining a building or geographic area to designate as a location-of-interest based at least in part on the time-stamped historical coordinates.

7. The computer-implemented method claim 1, wherein determining the set of authorized locations is further based at least in part on a maximum number of authorized locations.

8. The computer-implemented method of claim 1, wherein the historical time period corresponds to a time period that is at least a first particular length of time prior to a present time and no more than a second particular length of time prior to the present time, and wherein the first particular length of time is shorter than the second particular length of time.

9. The computer-implemented method of claim 1, further comprising:
the historical time period corresponds to a time period that is at least a first particular length of time prior to a present time and no more than a second particular length of time prior to the present time, and wherein the first particular length of time is shorter than the second particular length of time; and
wherein time-stamps of the set of historical time-stamped coordinates are time-stamped by the one or more user devices, and wherein determining the set of authorized locations is based at least in part on historical time-stamped coordinates that have a time-stamp within a first time difference from a corresponding receipt time.

10. The computer-implemented method of claim 1, wherein the time-stamps of the set of historical time-stamped coordinates are immutably time-stamped by the one or more user devices.

11. A system, comprising:
a storage medium configured to store computer-executable instructions; and
one or more processors coupled to the storage medium and configured to execute the computer-executable instructions to at least:
receive a set of historical time-stamped coordinates for one or more user devices associated with an account, the set of historical time-stamped coordinates corresponding to a historical time period;
determine a set of authorized locations based at least in part on the historical time-stamped coordinates and corresponding to clusters of historical time-stamped coordinates;
receive a request determining whether a current location of a first user device is an authorized location;
determine whether the current location of the first user device corresponds to one of the set of authorized locations;
in accordance with determining that the current location of the first user device corresponds to one of the set of authorized locations, transmit a confirmation indicating that the current location of the first user device corresponds to one of the set of authorized locations; and
in accordance with determining that the current location of the first user device does not correspond to one of the set of authorized locations, transmit a response that the current location of the first user device does not correspond to one of the set of authorized locations.

12. The system of claim 11, wherein determining the set of authorized locations includes:
determining a set of historical locations based at least in part on the historical time-stamped coordinates, the set of historical locations corresponding to clusters of time-stamped coordinates;
determining an amount of time at each of the set of historical locations based at least in part on the time-stamped historical coordinates; and
determining the set of authorized locations based at least in part on the amount of time at each of the set of historical locations.

13. The system of claim 11, wherein determining the set of authorized locations is further based at least in part on a minimum amount of time at a historical location.

14. The system of claim 11, wherein determining the set of authorized locations includes:
determining a set of historical locations based at least in part on the historical time-stamped coordinates, the set of historical locations corresponding to clusters of time-stamped coordinates;
determining individual visits to the set of historical locations based at least in part on the time-stamped historical coordinates, each visit of the individual visits including an arrival and a departure; and
determining the set authorized locations based at least in part on a minimum number of visits.

15. The system of claim 14, wherein determining the set of authorized locations further includes:
identifying arrivals for each of the set of historical locations based at least in part on a minimum amount of time at each historical location; and
identifying departures for each of the set of historical locations based at least in part on identifying an arrival for each historical location and receiving subsequent historical time-stamped coordinates at a different location.

16. One or more non-transitory computer-readable media comprising computer-executable instructions that, when executed by one or more processors of a computer system, cause the computer system to perform operations, comprising:
receiving a set of historical time-stamped coordinates for one or more user devices associated with an account, the set of historical time-stamped coordinates corresponding to a historical time period;
determining a set of authorized locations based at least in part on the historical time-stamped coordinates and corresponding to clusters of historical time-stamped coordinates;
receiving a request determining whether a current location of a first user device is an authorized location;
determining whether the current location of the first user device corresponds to one of the set of authorized locations;
in accordance with determining that the current location of the first user device corresponds to one of the set of authorized locations, transmitting a confirmation indicating that the current location of the first user device corresponds to one of the set of authorized locations; and
in accordance with determining that the current location of the first user device does not correspond to one of the set of authorized locations, transmitting a response that the current location of the first user device does not correspond to one of the set of authorized locations.

17. The one or more non-transitory computer-readable media of claim 16, wherein determining the set of authorized locations includes:
determining a set of historical locations based at least in part on the historical time-stamped coordinates, the set of historical locations corresponding to clusters of time-stamped coordinates;
determining an amount of time at each of the set of historical locations based at least in part on the time-stamped historical coordinates; and
determining the set of authorized locations based at least in part on the amount of time at each of the set of historical locations.

18. The one or more non-transitory computer-readable media of claim 16, wherein determining the set of authorized locations is further based at least in part on a minimum amount of time at a historical location.

19. The one or more non-transitory computer-readable media of claim 16, wherein determining the set of authorized locations includes:
determining a set of historical locations based at least in part on the historical time-stamped coordinates, the set of historical locations corresponding to clusters of time-stamped coordinates;
determining individual visits to the set of historical locations based at least in part on the time-stamped historical coordinates, each visit of the individual visits including an arrival and a departure; and determining the set authorized locations based at least in part on a minimum number of visits.

20. The one or more non-transitory computer-readable media of claim 19, wherein determining the set of authorized locations further includes:
identifying arrivals for each of the set of historical locations based at least in part on a minimum amount of time at each historical location; and
identifying departures for each of the set of historical locations based at least in part on identifying an arrival for each historical location and receiving subsequent historical time-stamped coordinates at a different location.
